(19) United States
(12) Patent Application Publication
(10) Pub. No.: US 2005/0261790 A1
(43) Pub. Date: Nov. 24, 2005

(54) Method and apparatus to correct erroneous audio data and a digital audio signal processing system employing the same

(76) Inventors: Jae-ha Park, Yongin-si (KR); Hyuck-jae Lee, Seoul (KR)

Correspondence Address: STANZIONE & KIM, LLP, 919 18TH STREET, N.W., SUITE 440, WASHINGTON, DC, 20006, US

(21) Appl. No.: 11/072,619

(22) Filed: Mar. 7, 2005

(30) Foreign Application Priority Data
May 24, 2004 (KR) 2004-36963

(51) Int. Cl. G06F 17/00

(52) U.S. Cl. 700/94

(57) ABSTRACT

A method and apparatus to correct erroneous audio data when reproducing the audio data in a magnetic tape audio system having a cylindrical head structure, and a digital audio signal processing system. A method of interpolating erroneous audio samples between normal audio samples in a reproducing apparatus, in which a plurality of normal audio samples and erroneous audio samples are generated periodically comprises counting a number of erroneous samples based on a number of error flags, and when at least one erroneous sample is counted between a first normal sample and a second normal sample, calculating a first value obtained by adding a first product of the first normal sample value and a first weight and a second product of the second normal sample value and a second weight, calculating a second value located on a continuous line of the first normal sample or the second normal sample, and setting a mean value of the first value and the second value to a sample value of a position where the error is generated. The audio sample interpolation method corrects audio errors generated in reproducing apparatuses using a cylindrical head or a rotary head and remarkably reduces harmonic components generated when the errors are corrected, thereby increasing clarity of reproduced sound.

### CROSS-REFERENCE TO RELATED APPLICATIONS

This application claims priority from Korean Patent Application No. 10-2004-36963, filed on May 24, 2004 in the Korean Intellectual Property Office, the disclosure of which is incorporated herein in its entirety by reference.

### BACKGROUND OF THE INVENTION

1. Field of the Invention

The present general inventive concept relates to an audio error correcting system, and more particularly, to a method and an apparatus to correct an error when reproducing a magnetic tape in an audio system having a cylindrical head structure, and a digital audio signal processing system employing the method and apparatus.

2. Description of the Related Art

Apparatuses for recording/reproducing a digital audio signal include audio-only apparatuses, such as compact disc (CD) players, mini disk (MD) players, and digital audio tape (DAT) recorders, and apparatuses for recording/reproducing a digital audio signal related to image data, such as digital video cassette recorders (VCRs). Since these digital audio signal recording/reproducing apparatuses cannot avoid errors generated during a recording/reproducing process, the apparatuses take countermeasures against such errors using an error correction code. In particular, an audio reproducing apparatus using a cylindrical or rotary head and a recording medium (tape), may periodically reproduce two or three normal samples (i.e., non-erroneous) and then erroneous samples. In a conventional method used to reduce an effect of errors, interpolation values for the erroneous samples are determined using temporally adjacent normal samples.

FIG. 1 is a conceptual diagram illustrating a conventional linear interpolation method used when two erroneous samples are generated in between normal samples.

A commonly used linear interpolation equation that corresponds to the conventional linear interpolation method is given by Equation 1:
y(n+w)=(1−w)·y(n)+w·y(n+1) [Equation 1]

Here, w is a number between 0 and 1 used to interpolate a signal y between a time “n” and a time “n+1.”

Referring to FIG. 1 and [Equation 1], a first erroneous sample “c” is set by adding a value obtained by multiplying a normal sample “a” by a weight of ⅔ and a value obtained by multiplying a normal sample “b” by a weight of ⅓. A second erroneous sample “d” is set by adding a value obtained by multiplying the normal sample “a” by a weight of ⅓ and a value obtained by multiplying the normal sample “b” by a weight of ⅔. That is, a first process to obtain an interpolation value of the first erroneous sample “c” is PROCESS1=⅔a+⅓b, and a second process to obtain an interpolation value of the second erroneous sample “d” is PROCESS2=⅓a+⅔b. FIG. 2 illustrates a result of applying the conventional linear interpolation method.

However, as illustrated in FIG. 3, the conventional linear interpolation method generates a number of harmonic components. Referring to FIG. 3, harmonic components at 7000 Hz, 9000 Hz, and 15000 Hz are generated against an original signal at 1000 Hz when more than two erroneous samples are interpolated between normal samples using the conventional linear interpolation method illustrated in FIG. 1. The harmonic components appear with 30 dB-lower levels than the original signal. That is, if an error is generated in only one sample, it does not matter and the conventional interpolation method may be used. However, if errors are generated in more than one sample, since the harmonic components (7000 Hz, 9000 Hz, and 15000 Hz) are generated against the original signal (1000 Hz) as illustrated in FIGS. 2 and 3, sound quality is dramatically deteriorated.

### SUMMARY OF THE INVENTION

The present general inventive concept provides a method and an apparatus to interpolate erroneous audio samples between normal audio samples using values estimated by a conventional linear interpolation method and values located on a continuous line of samples, in a reproducing apparatus in which a plurality of normal samples and erroneous samples are periodically generated.

The present general inventive concept also provides an audio signal processing system employing the audio sample interpolation method and apparatus.

Additional aspects and advantages of the present general inventive concept will be set forth in part in the description which follows and, in part, will be obvious from the description, or may be learned by practice of the general inventive concept.

The foregoing and/or other aspects and advantages of the present general inventive concept may be achieved by providing a method of interpolating erroneous audio samples between normal audio samples in a reproducing apparatus, in which a plurality of normal audio samples and erroneous audio samples are generated periodically, the method comprising counting a number of erroneous samples based on a number of error flags, and when at least one erroneous sample is counted between a first normal sample and a second normal sample, calculating a first value obtained by adding a first product of the first normal sample value and a first weight and a second product of the second normal sample value and a second weight, calculating a second value located on a continuous line of the first normal sample or the second normal sample, and setting a mean value of the first value and the second value to a sample value of a position where the error is generated.

The foregoing and/or other aspects and advantages of the present general inventive concept may also be achieved by providing an audio error correcting apparatus to interpolate erroneous samples, the apparatus comprising a counter to count a number of erroneous samples based on a number of error flags, and an interpolator, when at least one erroneous sample is counted between a first normal sample and a second normal sample, to calculate a first value obtained by adding a first product of the first normal sample value and a first weight and a second product of the second normal sample value and a second weight, to calculate a second value located on a continuous line of the first normal sample or the second normal sample, and to set a mean value of the first value and the second value to a sample value of a position in which the error is generated.

The foregoing and/or other aspects and advantages of the present general inventive concept may also be achieved by providing a digital audio signal processing system to interpolate erroneous samples, the system comprising a decoder to decode audio data reproduced from a deck and to perform error correction on the decoded audio data using an error correction code, a storage unit to store the audio data decoded by the decoder and one or more error flags indicating whether there are errors in one or more corresponding samples, and a signal processor to interpolate erroneous sample values between normal samples using mean values of linear-interpolated values and values located on continuous lines of the normal samples in response to the one or more error flags stored in the storage unit.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a conceptual diagram illustrating a conventional linear interpolation method;

FIG. 2 is a graph illustrating results of applying the conventional linear interpolation method of FIG. 1;

FIG. 3 is a graph illustrating a frequency characteristic of the conventional linear interpolation method of FIG. 1;

FIG. 4 is a block diagram illustrating an audio recording/reproducing system to which an audio error correcting method according to an embodiment of the present general inventive concept is applied;

FIG. 5 is a detailed block diagram illustrating a signal processor of FIG. 4 according to an embodiment of the present general inventive concept;

FIG. 6 is a conceptual diagram illustrating interpolation of erroneous samples between normal samples in an interpolator of FIG. 5;

FIG. 7 is a conceptual diagram illustrating interpolation of two erroneous samples between normal samples in the signal processor of FIG. 4;

FIG. 8 is a conceptual diagram illustrating interpolation of three erroneous samples between normal samples in the signal processor of FIG. 4;

FIGS. 9A and 9B are flowcharts illustrating a method of interpolating audio samples in the signal processor of FIG. 4;

FIG. 10 is a graph illustrating a restored audio sample to which the interpolation method of FIGS. 9A and 9B has been applied; and

FIG. 11 is a graph illustrating a frequency characteristic produced by the interpolation method of FIGS. 9A and 9B.

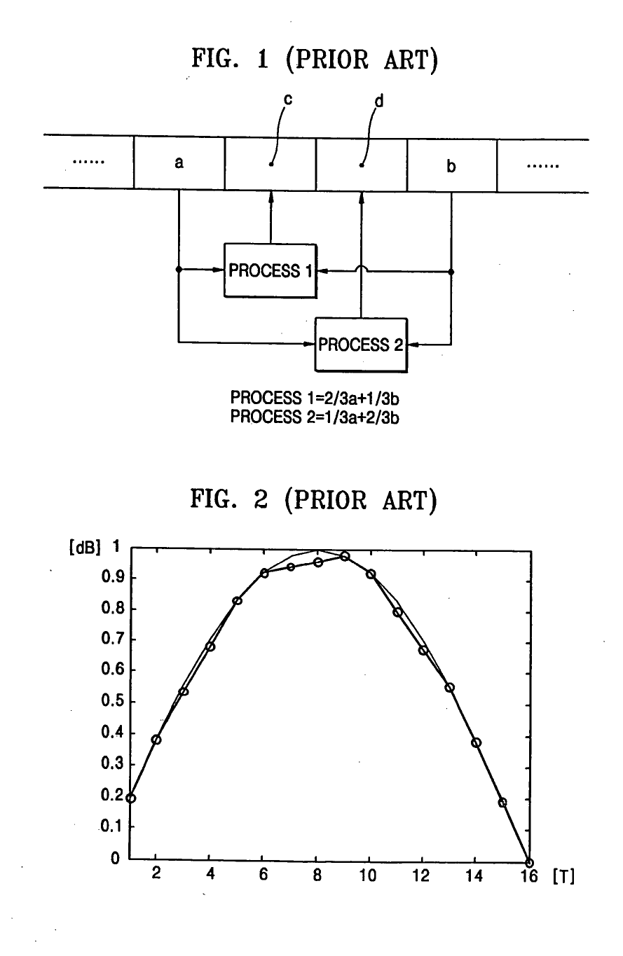

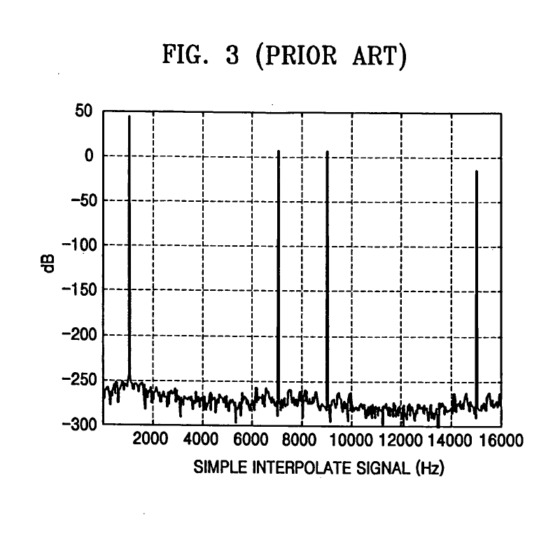

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept while referring to the figures.

In a general audio recording/reproducing system, a mecha deck includes a pair of magnetic heads installed on a rotating drum 180° apart from each other, a magnetic tape wrapped around the rotating drum, and a tape traveling assembly that guides the magnetic tape along a predetermined path.

On the magnetic tape, a signal is alternately recorded by the pair of magnetic heads, and inclined tracks are sequentially formed. In a 525-line/60-field magnetic tape, a video signal and an audio signal of 1 frame are recorded on 10 tracks. Track numbers 0 through 9 are assigned to these tracks. Each track has an area on which video data is recorded and an area on which a sub code is recorded. One sample of the audio signal is composed of 16 bits, and the audio signal is digitalized with a sampling frequency of 48 kHz, 44.1 kHz, or 32 kHz. The audio signal includes two channels and a signal of one channel is recorded on the first half of the 10 tracks, and a signal of the other channel is recorded on the remaining 5 tracks. The number of audio samples included in one frame is 1620 (D0-D1619).

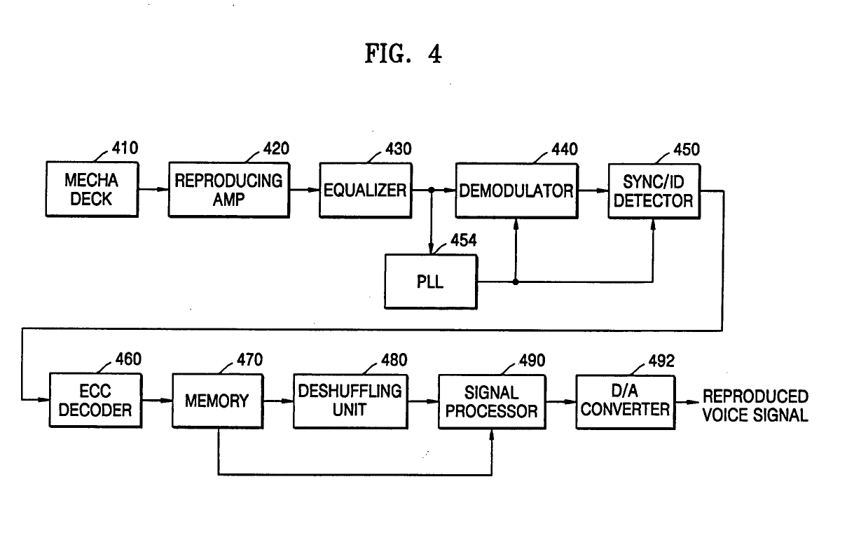

FIG. 4 is a block diagram illustrating an audio recording/reproducing system to which an audio error correcting method according to an embodiment of the present general inventive concept is applied.

Referring to FIG. 4, a signal reproduced from a mecha deck 410 is provided to an equalizer 430 through a reproducing amp 420. An output signal of the equalizer 430 is provided to a demodulator 440 and a phase-locked loop (PLL) 454. For example, the demodulator 440 converts 24-bit data into a 25-bit codeword. An output signal of the demodulator 440 is provided to a sync/ID detector 450. Recorded data is composed of sync blocks. A sync block includes sync data in a header, an ID, data (video data, audio data, or a sub code), and a parity component added to the sync block, in that order. The PLL 454 generates a clock synchronized with the reproduced signal and provides the clock to the demodulator 440 and the sync detector 450.

An output signal of the sync detector 450 is provided to an error correction code (ECC) decoder 460. The ECC decoder 460 decodes an error correction code and corrects erroneous samples of the reproduced signal. For example, a product code may be used for the error correction code. For illustration purposes, description of signal processing for the video data and the sub code is omitted, and only signal processing of the audio data from the latter part of the ECC decoder 460 will be described. However, it should be understood that the present general inventive concept is usable with the video data and/or the sub code.

Error flags indicating whether errors are generated in data and samples decoded by the ECC decoder 460 are stored in a memory 470. A deshuffling unit 480 is combined with the memory 470 and deshuffles data that was shuffled when the data was recorded.

Even though the errors are corrected by the ECC decoder 460, if a foreign substance exists on one of the magnetic heads, errors are generated when the audio data is reproduced. For example, a head1 and a head2 are included in the magnetic heads. If the foreign substance exists on the head1, a track0, a track2, and a track4 cannot be read. Accordingly, not only data samples (D0, D5, D10, . . . , D1615) of the track0 but also data samples (D1, D6, D11, . . . , D1616) of the track2 and data samples (D2, D7, D12, . . . , D1617) of the track4 are considered erroneous.

Referring to the deshuffled data, a repeating pattern of three erroneous data samples followed by two normal (i.e., non-erroneous) data samples, or two erroneous data samples followed by three normal data samples, is periodically generated when the deshuffled data is reproduced.

A signal processor 490 interpolates the erroneous samples periodically generated between the normal samples of data deshuffled by the deshuffling unit 480 using previous and subsequent normal samples in response to the error flags input from the memory 470.

A digital to analog (D/A) converter 492 reproduces audio samples output from the signal processor 490, as an analog signal or a reproduced voice signal.

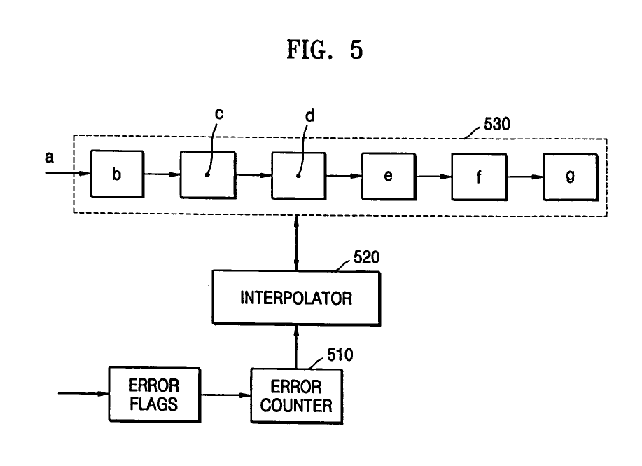

FIG. 5 is a detailed block diagram illustrating the signal processor 490 of FIG. 4 according to an embodiment of the present general inventive concept.

A 16-bit sample “a” of the audio data is input to a buffer 530. An error flag indicating whether an error has been generated in the sample is provided to an error counter 510. The error counter 510 counts error flags.

If two erroneous samples have been generated, the buffer 530 stores normal samples “a,” “b,” “e,” and “f,” and erroneous samples “c” and “d,” generated when the audio data is reproduced. Alternatively, if three erroneous samples have been generated, the buffer 530 can store three erroneous samples “c,” “d,” and “e” between normal samples “a” and “b” and “f” and “g.” The normal samples and the erroneous samples may be repeated periodically among the audio data due to the foreign substance existing on one of the magnetic heads.

An interpolator 520 calculates interpolation values of the erroneous samples “c” and “d” using the samples “a,” “b,” “e,” and “f” stored in the buffer 530 when the error counter 510 counts two erroneous samples. The interpolation values of the erroneous samples “c” and “d” are set using values estimated by the conventional linear interpolation method and values located on continuous lines of the normal samples. Alternatively, the interpolator 520 calculates interpolation values of the erroneous samples “c,” “d,” and “e” using the samples “a,” “b,” “f,” and “g” stored in the buffer 530 when the error counter 510 counts three erroneous samples. The interpolation values of the erroneous samples “c,” “d,” and “e” are set using values estimated by the conventional linear interpolation method and values located on continuous lines of the normal samples.

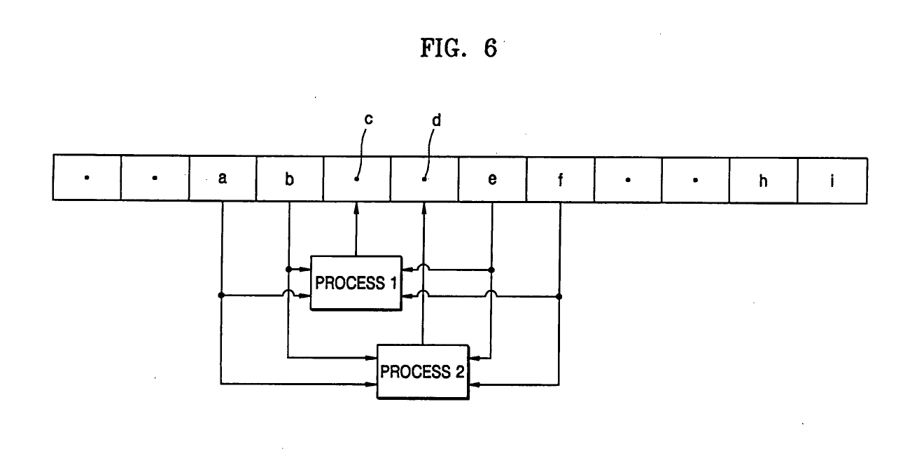

FIG. 6 is a conceptual diagram illustrating interpolation of erroneous samples between normal samples in the interpolator 520 of FIG. 5.

Referring to FIG. 6, an equation for a first interpolation of the sample “c” is {(⅔*b+⅓*e)+(2*b-a)}/2, and an equation for a second interpolation of the sample “d” is {(⅓*b+⅔*e)+(2*e-f)}/2.

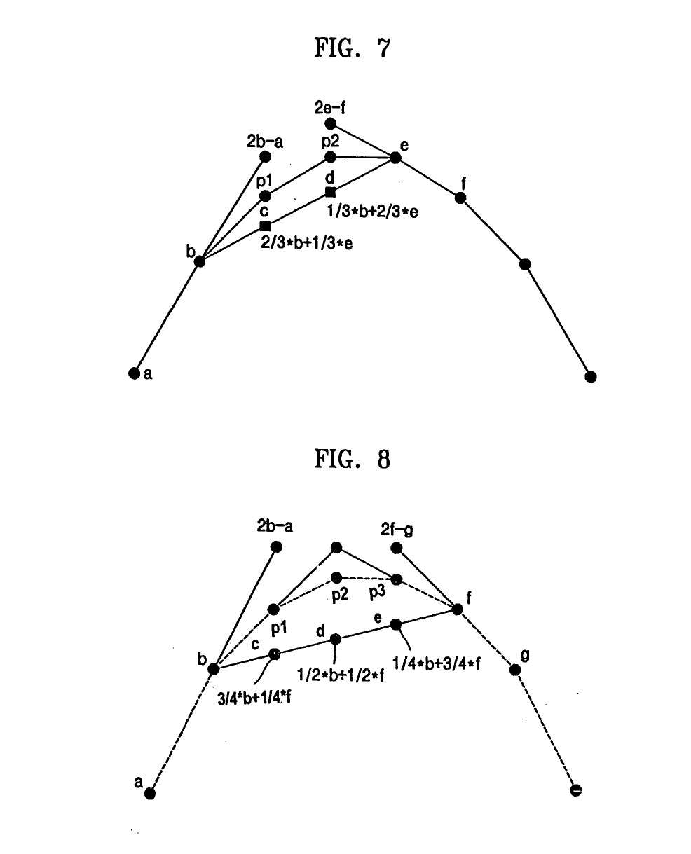

FIG. 7 is a conceptual diagram illustrating interpolation of two erroneous samples between normal samples in the signal processor 490 of FIG. 4.

Referring to FIG. 7, two erroneous samples “c” and “d” to be interpolated between a sample “b” and a sample “e” are set. That is, a first interpolation sample p1 is set to a mean value of a first value (⅔*b+⅓*e) of the sample “c” obtained by adding a value (⅔*b) obtained by multiplying “b” by a weight of ⅔ and a value (⅓*e) obtained by multiplying “e” by a weight of ⅓ and a second value (2b-a) of the sample “c” located on a continuous line of the sample “b” and a previous sample “a.” A second interpolation sample p2 is set to a mean value of a first value (⅓*b+⅔*e) of sample “d” obtained by adding a value (⅓*b) obtained by multiplying “b” by a weight of ⅓ and a value (⅔*e) obtained by multiplying “e” by a weight of ⅔, and a second value (2e-f) of sample “d” located on a continuous line of the sample “e” and a subsequent sample “f.”

FIG. 8 is a conceptual diagram illustrating interpolation of three erroneous samples between normal samples in the signal processor 490 of FIG. 4.

Referring to FIG. 8, three erroneous samples “c,” “d,” and “e” to be interpolated between a sample “b” and a sample “f” are set. That is, a first interpolation sample “c” is set to {(¾*b+¼*f)+(2*b-a)}/2, a second interpolation sample “d” is set to {(½*b+½*f)+(2*c-b)+(2*e-f)}/3, and a third interpolation sample “e” is set to {(¼*b+¾*f)+(2*f-g)}/2.

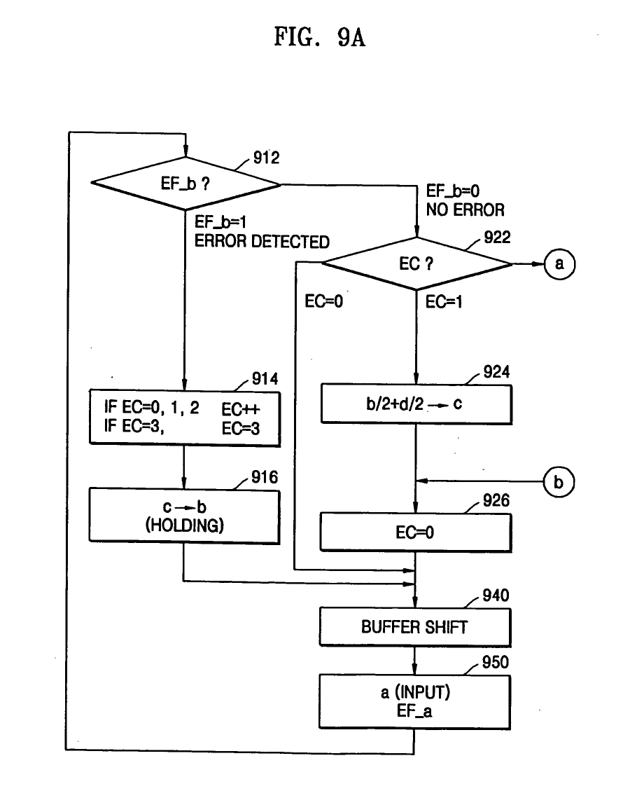

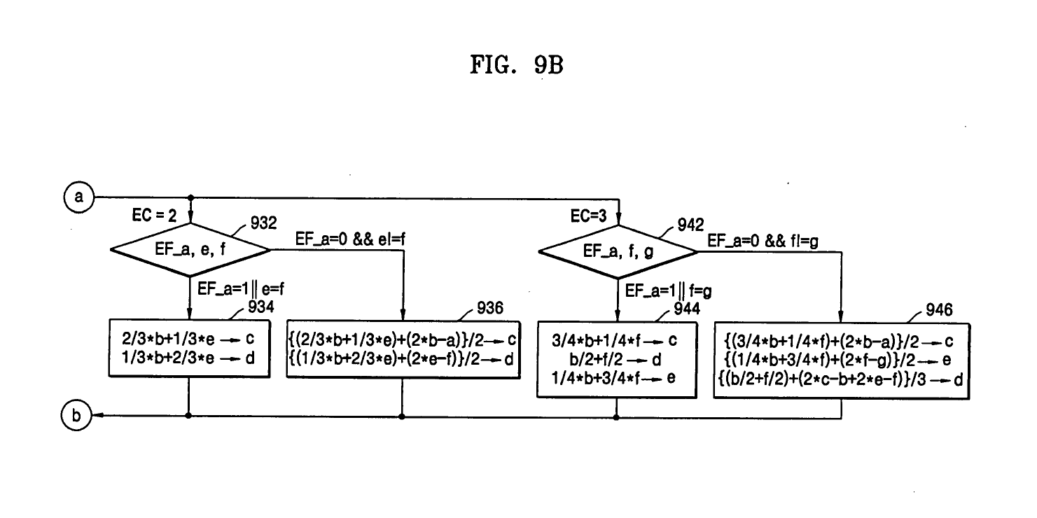

FIGS. 9A and 9B are flowcharts illustrating a method of interpolating audio samples in the signal processor 490 of FIG. 4. Points “a” and “b” in FIG. 9A refer to points where operations illustrated in FIG. 9B are performed.

The interpolator 520 determines whether there is an error in a sample “b” using an error flag EF_b in operation 912. If the error flag EF_b indicates that there is an error in the sample “b” (i.e., EF_b=1) in operation 912, an error count value is checked. If the error count value is 0, 1, or 2, the error count value is increased by 1, and if the error count value is 3, the error count value remains at 3, in operation 914. At this time, an erroneous sample value “c” is set to the erroneous sample value “b” by holding the erroneous sample value “b” in operation 916.

If the error flag EF_b indicates that there is no error in sample “b” (i.e., EF_b=0) in operation 912, the error count value is checked in operation 922. At this time, according to the error count value, the following interpolation operations performed:

1) If the error count value is 0, an interpolation is not performed.

2) If the error count value is 1, the erroneous sample “c” between the sample “b” and a sample “d” is interpolated using a conventional linear interpolation equation, for example, b/2+d/2. After the interpolation, the error count value becomes 0, in operation 926.

3) If the error count value is 2, different interpolation equations are used according to a state of an error flag EF_a indicating whether there is an error in sample “a,” a value of sample “e”, and a value of sample “f”, in operation 932. That is, if the error flag EF_a of sample “a” is 1 (i.e., sample “a” is erroneous), and if the value of sample “e” and the value of sample “f” are equal to each other, erroneous samples “c” and “d” are set using interpolation equations (⅔*b+⅓*e and ⅓*b+⅔*e), in operation 934. If the error flag EF_a of sample “a” is 0 (i.e., sample “a” is normal), and if the value of sample “e” and the value of sample “f” are not equal to each other, the erroneous samples “c” and “d” are set using an interpolation equation according the present embodiment of the general inventive concept, in operation 936. That is, the erroneous sample “c” is set to {(⅔*b+⅓*e)+(2*b-a)}/2, and the erroneous sample “d” is set to {(⅓*b+⅔*e)+(2*e-f)}/2.

4) If the error count value is 3, different interpolation equations are used according to a state of the error flag EF_a indicating whether there is an error in the sample “a”, a value of sample “f,” and a value of sample “g,” in operation 942. That is, if the error flag EF_a of sample “a” is 1 (i.e., sample “a” is erroneous), and the values of samples “f” and “g” are equal, erroneous samples “c,” “d,” and “e” are set using interpolation equations (¾*b+¼*f, ½*b+½*f, and ¼*b+¾*f), in operation 944. If the error flag EF_a of sample “a” is 0 (i.e., sample “a” is normal), and the values of samples “f” and “g” are not equal, the erroneous samples “c,” “d,” and “e” are set using an interpolation according to the present embodiment of the general inventive concept, in operation 946. That is, the erroneous sample “c” is set to {(¾*b+¼*f)+(2*b-a)}/2, the erroneous sample “d” is set to {(½*b+½*f)+(2*c-b)+(2*e-f)}/3, and the erroneous sample “e” is set to {(¼*b+¾*f)+(2*f-g)}/2.

After the interpolation, the error count value becomes 0, in operation 926.

A buffer shift process is performed to examine another group of samples in the audio data in operation 940.

After the buffer shifts to samples “b,” “c,” “d,” “e,” and “f,” a subsequent new sample “a” is input to the interpolator in operation 950. Operations 912 through 950 are continuously repeated for the remaining audio data. Although a buffer size used to describe the present embodiment includes six or seven samples depending on the error count, it should be understood that other buffer sizes may be used with the present general inventive concept.

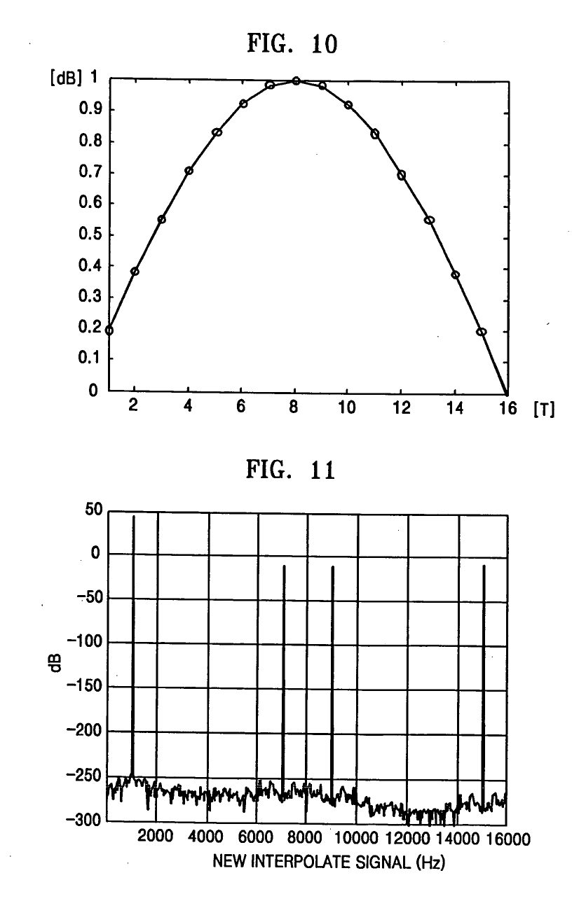

FIG. 10 is a graph illustrating a restored audio sample to which the interpolation method according to an embodiment of the present general inventive concept has been applied.

Comparing FIG. 10 with FIG. 2, which illustrates the restored audio data to which the conventional interpolation method has been applied, it can be seen that the interpolation method of the present embodiment of the general inventive concept interpolates erroneous samples between normal samples more smoothly than the conventional interpolation method.

FIG. 11 is a graph showing a frequency characteristic of the interpolation method according to an embodiment of the present general inventive concept.

Referring to FIG. 11, harmonic components are largely reduced compared to the conventional frequency characteristic. For example, the interpolation method of the present embodiment of the general inventive concept reduces the harmonic components by 15 dB-20 dB, compared to the conventional interpolation method.

The present general inventive concept may be implemented in hardware, software, or a combination thereof. The present general inventive concept can also be embodied as computer-readable codes on a computer-readable recording medium. The computer-readable recording medium may include any data storage device that can store data which can thereafter be read by a computer system. Examples of the computer-readable recording medium include read-only memory (ROM), random-access memory (RAM), CD-ROMs, magnetic tapes, floppy disks, optical data storage devices, and carrier waves (such as data transmission over the Internet). The computer-readable recording medium can also be distributed over a network of coupled computer systems so that the computer-readable code is stored and executed in a decentralized fashion.

As described above, since an audio sample interpolation method according to an embodiment of the present general inventive concept corrects audio errors generated in reproducing apparatuses using a cylindrical or a rotary head (e.g., camcorders, video cassette players, etc.), and remarkably reduces harmonic components generated when the errors are corrected so that audio data can be more clearly reproduced.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

1. A method of interpolating erroneous audio samples between normal audio samples in a reproducing apparatus, in which a plurality of normal audio samples and erroneous audio samples are generated periodically, the method comprising:
counting a number of erroneous samples based on a number of error flags; and
when at least one erroneous sample is counted between a first normal sample and a second normal sample, calculating a first value obtained by adding a first product of a first normal sample value and a first weight and a second product of a second normal sample value and a second weight, calculating a second value located on a continuous line of the first sample or the second sample, and setting a mean value of the first value and the second value to a sample value of a position where the erroneous sample exists.

2. The method of claim 1, wherein the first weight and the second weight are adjusted according to distances between the first and second normal samples, respectively.

3. The method of claim 1, wherein the second value located on the continuous line of the first sample or the second sample is a value obtained by subtracting a previous or subsequent sample of the first or second normal sample value from twice the first normal sample value or twice the second normal sample value, respectively.

4. The method of claim 1, wherein the first weight is a value between 0 and 1.

5. The method of claim 1, wherein the second weight is a value between 0 and 1.

6. The method of claim 1, wherein, if it is determined that two erroneous samples exist as a first erroneous sample and a second erroneous sample between the first normal sample and the second normal sample, the setting of the mean value comprises setting a first mean value of a third value obtained by adding a third product of the first normal sample value and a third weight and a fourth product of the second normal sample value and a fourth weight, which is less than the third weight, and a fourth value located on the continuous line of the first normal sample and a previous normal sample of the first normal sample, to a first interpolation sample value for the first erroneous sample, and setting a second mean value of a fifth value obtained by adding a fifth product of the first normal sample value and a fifth weight and a sixth product of the second normal sample value and a sixth weight, which is larger than the fifth weight, and a sixth value located on the continuous line of the second normal sample and a subsequent sample of the second normal sample, to a second interpolation sample value for the second erroneous sample.

7. The method of claim 6, wherein the fourth value for the first erroneous sample located on the continuous line of the first normal sample and the previous sample of the first normal sample is obtained by subtracting a previous normal sample value of the previous normal sample from twice the first normal sample value.

8. The method of claim 6, wherein the sixth value for the second erroneous sample located on the continuous line of the second normal sample and the subsequent sample of the second normal sample is obtained by subtracting a subsequent sample value of the subsequent sample from twice the second normal sample value.

9. A method of correcting errors in an audio signal reproduced by an audio system, the method comprising:
receiving a signal having a plurality of samples;
determining a number of erroneous samples between a first normal sample and a second normal sample;
averaging a first normal sample value and a second normal sample value to determine a first erroneous sample when the number of erroneous samples equals one; and
determining a linear interpolation value of the first erroneous sample with respect to a distance from the first normal sample and the second normal sample, determining a value of a point on a line between the first normal sample and a normal sample previous to the first normal sample that corresponds to the first erroneous sample, and averaging the linear interpolation value and the value of the point on the line to determine the first erroneous sample when the number of erroneous samples equals two or more.

10. A method of correcting errors in an audio signal reproduced by an audio system, the method comprising:
receiving an audio signal having at least a first normal sample, a first erroneous sample, a second erroneous sample, and a second normal sample, respectively;
determining a first linear interpolation value of the first erroneous sample by performing a weighted average of the first normal sample and the second normal sample according to respective distances from the first erroneous sample to the first and second normal samples;
extrapolating a first line between the first normal sample and a previous normal sample of the first normal sample to a point that corresponds to the first erroneous sample and determining a corresponding value of the first line at that point to be a first linear extrapolation value; and
determining a value between the first linear extrapolation value and the first linear interpolation value as a final interpolation value of the first erroneous sample.

11. The method of claim 10, further comprising:
determining a second linear interpolation value of the second erroneous sample by performing a weighted average of the first normal sample and the second normal sample according to respective distances from the second erroneous sample to the first and second normal samples;
extrapolating a second line between the second normal sample and a subsequent normal sample of the second normal sample to a point that corresponds to the second erroneous sample and determining a corresponding value of the second line at that point to be a second linear extrapolation value; and
determining a value between the second linear extrapolation value and the second linear interpolation value as a final interpolation value of the second erroneous sample.

12. The method of claim 11, wherein the audio signal further includes a third erroneous sample disposed between the first erroneous sample and the second erroneous sample, and the method further comprises:
determining a third linear interpolation value of the third erroneous sample by performing a weighted average of the first normal sample and the second normal sample according to respective distances from the third erroneous sample to the first and second normal samples;
determining two third linear extrapolation values according to where the first line and the second line correspond to the third erroneous sample, respectively; and
averaging the third linear interpolation value and the two third linear extrapolation values to determine a final interpolation value of the third erroneous sample.

13. A method of correcting errors in an audio signal reproduced by an audio system, the method comprising:
receiving an audio signal including a plurality of normal samples and at least one erroneous sample;
determining a number and a position of the at least one erroneous sample;
determining a first average of two surrounding normal sample values that surround an erroneous sample as a final interpolation value of the erroneous sample when it is determined that the number of the at least one erroneous sample is one; and
determining a second average between a linear interpolation value of the erroneous sample and a linear extrapolation value of the erroneous sample as the final interpolation value of the erroneous sample when it is determined that the number of the at least one erroneous sample is greater than one,
wherein the linear interpolation value comprises a weighted average of the two surrounding normal samples according to respective distances from the erroneous sample, and the linear extrapolation value is determined by extrapolating a line between a pair of consecutive normal samples that is closest to the erroneous sample to a point that corresponds to the erroneous sample, and determining a corresponding value as the linear extrapolation value.

14. The method of claim 13, wherein the plurality of normal samples and the at least one erroneous sample are repeated periodically due to reproduction of audio data of the audio signal by a rotary head of the audio system.

15. The method of claim 13, wherein if a pair of consecutive normal samples closest to the erroneous sample does not exist, selecting the linear interpolation value as the final interpolation value of the erroneous sample.

16. The method of claim 15, wherein the plurality of normal samples and the at least one erroneous sample comprise a sample A, a sample B, a sample C, a sample D, a sample E, a sample F, and a sample G.

17. The method of claim 16, wherein if the sample A, the sample C, and the sample D are erroneous and a value of the sample E is equal to a value of the sample F, then a final interpolation value of the sample C is determined by ⅔*B+⅓*E and a final interpolation value of the sample D is determined by ⅓*B+⅔*E.

18. The method of claim 16, wherein if the sample C and the sample D are erroneous and a value of the sample E is not equal to a value of the sample F, then a final interpolation value of the sample C is determined by [(⅔*B+⅓*E)+(2*B-A)]/2 and a final interpolation value of the sample D is determined by [(⅓*B+⅔*E)+(2*E-F)]/2.

19. The method of claim 16, wherein if the sample A, the sample C, the sample D, and the sample E are erroneous and a value of the sample F is equal to a value of the sample G, then a final interpolation value of the sample C is determined by ¾*B+¼*F, a final interpolation value of the sample D is determined by B/2+F/2, and a final interpolation value of the sample E is determined by ¼*B+¾*F.

20. The method of claim 16, wherein if the sample C, the sample D, and the sample E are erroneous and a value of the sample F is not equal to a value of the sample G, then a final interpolation value of the sample C is determined by [(¾*B+¼*F)+(2*B-A)]/2, a final interpolation value of the sample D is determined by [(B/2+F/2)+(2*C-B+2*E-F)]/3, and a final interpolation value of the sample E is determined by [(¼*B+¾*F)+(2*F-G)]/2.

21. A method of interpolating more than one erroneous sample in a plurality of samples, the method comprising:
receiving a signal including the plurality of samples having at least first and second erroneous samples that are adjacent to each other;
determining two surrounding non-erroneous samples being closest non-erroneous samples to the at least first and second erroneous samples and on opposite sides of the at least first and second erroneous samples with respect to each other;
determining whether two samples falling outside the two surrounding non-erroneous samples opposite to the at least first and second erroneous samples, respectively, are erroneous;
interpolating values of the at least first and second erroneous samples according to values of the surrounding non-erroneous samples and values of the two samples falling outside the surrounding non-erroneous samples when it is determined that the two samples falling outside the surrounding non-erroneous samples are also non-erroneous; and
interpolating the values of the at least first and second erroneous samples according to values of the surrounding non-erroneous samples when it is determined that the two samples falling outside the surrounding non-erroneous samples are erroneous.

22. An audio error correcting method of interpolating three erroneous samples “c,” “d,” and “e” between a first sample “b” and a sample “a” that precedes the first sample “b” and a second sample “f” and a sample “g” that succeeds the second sample “f”, in a reproducing apparatus in which three normal samples and three erroneous samples are generated periodically, the method comprising:
counting a number of erroneous samples based on a number of error flags; and
if it is determined that errors are generated in the three samples between the first sample “b” and the second sample “f”, the erroneous sample “c” is set to {(¾*b+¼*f)+(2*b-a)}/2, the erroneous sample “d” is set to {(½*b+½*f)+(2*c-b)+(2*e-f)}/3, and the erroneous sample “e” is set to {(¼*b+¾*f)+(2*f-g)}/2.

23. An audio error correcting apparatus to interpolate erroneous samples, the apparatus comprising:
a counter to count a number of erroneous samples based on a number of error flags; and
an interpolator, when at least one erroneous sample is counted between a first normal sample and a second normal sample, to calculate a first value obtained by adding a first product of a first normal sample value and a first weight and a second product of a second normal sample value and a second weight, to calculate a second value located on a continuous line of the first normal sample or the second normal sample, and to set a mean value of the first value and the second value to a sample value of a position where the erroneous sample exists.

24. A digital audio signal processing system to interpolate erroneous samples, the system comprising:
a decoder to decode audio data reproduced from a deck and to perform error correction on the decoded audio data using an error correction code;
a storage unit to store the audio data decoded by the decoder and one or more error flags indicating whether there is an error in one or more corresponding samples; and
a signal processor to interpolate erroneous sample values between normal samples using a mean value of a linearly interpolated value and a value located on continuous lines of the normal samples in response to the one or more error flags stored in the storage unit.

25. The system of claim 24, wherein the signal processor comprises
a counter to count a number of erroneous samples based on a number of error flags stored in the memory; and
an interpolator, when at least one erroneous sample is counted, to interpolate the at least one erroneous sample between the normal samples using the mean value of the linearly interpolated value and a value located on a continuous line of the normal samples.

26. A signal processor to correct errors in a signal in an audio system, comprising:
an error counter to determine a number of erroneous samples between two selected non-erroneous samples; and
an interpolator to interpolate the erroneous samples between the two selected non-erroneous samples according to values of the two selected non-erroneous samples when it is determined that samples surrounding the two selected non-erroneous samples are erroneous, and to interpolate the erroneous samples between the two selected non-erroneous samples according to values of the two selected non-erroneous samples and values of the samples surrounding the two selected non-erroneous samples when it is determined that the samples surrounding the two selected non-erroneous samples are non-erroneous.

27. A signal processor to correct errors in an audio signal reproduced by an audio system, comprising:
an error counter to receive an audio signal including a plurality of normal samples and at least one erroneous sample and to determine a number and position of the at least one erroneous sample; and
an interpolator to determine an average of two surrounding sample values as a final interpolation value of an erroneous sample when it is determined that the number of the at least one erroneous sample is one, and to determine an average between a linear interpolation value of the erroneous sample and a linear extrapolation value of the erroneous sample as the final interpolation value when it is determined that the number of the at least one erroneous sample is greater than one,
wherein the linear interpolation value comprises a weighted average of the two surrounding normal samples according to respective distances from the erroneous sample and the linear extrapolation value is determined by extrapolating a line between a pair of consecutive normal samples that is closest to the erroneous sample to a point that corresponds to the erroneous sample and determining a corresponding value as the linear extrapolation value.

28. The signal processor of claim 27, wherein the plurality of normal samples and the at least one erroneous sample are repeated periodically due to reproduction of audio data of the audio signal by a pair of rotary heads of the audio system.

29. The signal processor of claim 27, further comprising:
a buffer to store a predetermined number of samples according to the number of the at least one erroneous sample and to shift the predetermined number of samples after the interpolator interpolates the at least one erroneous sample.

30. The signal processor of claim 29, wherein the plurality of normal samples and the at least one erroneous sample comprises a sample A, a sample B, a sample C, a sample D, a sample E, a sample F, and a sample G.

31. The signal processor of claim 30, wherein if the sample A, the sample C, and the sample D are erroneous and a value of the sample E is equal to a value of the sample F, then a final interpolation value of the sample C is determined by ⅔*B+⅓*E and a final interpolation value of the sample D is determined by ⅓*B+⅔*E.

32. The signal processor of claim 30, wherein if the sample C and the sample D are erroneous and a value of the sample E is not equal to a value of the sample F, then a final interpolation value of the sample C is determined by [(⅔*B+⅓*E)+(2*B-A)]/2 and a final interpolation value of the sample D is determined by [(⅓*B+⅔*E)+(2*E-F)]/2.

33. The signal processor of claim 30, wherein if the sample A, the sample C, the sample D, and the sample E are erroneous and a value of the sample F is equal to a value of the sample G, then a final interpolation value of the sample C is determined by ¾*B+¼*F, a final interpolation value of the sample D is determined by B/2+F/2, and a final interpolation value of the sample E is determined by ¼*B+¾*F.

34. The signal processor of claim 30, wherein if the sample C, the sample D, and the sample E are erroneous and a value of the sample F is not equal to a value of the sample G, then a final interpolation value of the sample C is determined by [(¾*B+¼*F)+(2*B-A)]/2, a final interpolation value of the sample D is determined by [(B/2+F/2)+(2*C-B+2*E-F)]/3, and a final interpolation value of the sample E is determined by [(¼*B+¾*F)+(2*F-G)]/2.

35. A computer readable medium to correct errors in an audio signal, the medium comprising:
first computer readable code to determine one or more erroneous samples in an error region from among a plurality of samples;
second computer readable code to determine whether there is a previous pair of non-erroneous samples adjacent to the error region and whether there is a subsequent pair of non-erroneous samples adjacent to the error region and opposite the previous pair of non-erroneous samples;
third computer readable code to interpolate values of the one or more erroneous samples in the error region according to values of the previous and subsequent pairs of non-erroneous sample values when there are the previous and subsequent pairs of non-erroneous samples; and
fourth computer readable code to interpolate values of the one or more erroneous samples in the error region according to values of a first previous sample adjacent to the error region and a first subsequent sample adjacent to the error region when there are no previous and subsequent pairs of non-erroneous samples.

36. The medium of claim 35, wherein the fourth computer readable code to interpolate values of the one or more erroneous samples in the error region according to values of the previous and subsequent pairs of non-erroneous sample values when there are the previous and subsequent pairs of non-erroneous samples comprises:
computer readable code to interpolate each of the one or more erroneous samples in the error region by averaging a linear interpolation value for a selected erroneous sample by calculating a weighted average of the first previous sample and the first subsequent sample according to respective distances from the selected erroneous sample, determining a linear extrapolation value by extrapolating a line between at least one of the previous pair of non-erroneous samples and the subsequent pair of non-erroneous samples to a point that corresponds to the selected erroneous sample, and determining an average value of the linear interpolation value and the extrapolation value.

37. The medium of claim 36, wherein the linear extrapolation value is determined according to the pair of non-erroneous samples that is closest to the selected erroneous value, and if the previous and subsequent pairs of non-erroneous samples are equidistant, the linear extrapolation value is determined according to both of the pairs of non-erroneous samples.
